(19) United States
(12) Patent Application Publication
(10) Pub. No.: US 2026/0046120 A1
(43) Pub. Date: Feb. 12, 2026

(54) QUANTUM DISTRIBUTION METHODS AND ASSOCIATED TELECOMMUNICATION DEVICES

(71) Applicant: THALES, MEUDON (FR)

(72) Inventor: Yann OSTER, TOULOUSE (FR)

(21) Appl. No.: 19/099,354

(22) PCT Filed: Jul. 27, 2023
(86) PCT No.: PCT/EP2023/070872

§ 371 Date: Feb. 21, 2025

(30) Foreign Application Priority Data
Jul. 28, 2022 (FR) 2207760

(51) Int. Cl. H04L 9/08; H04L 1/00

(52) U.S. Cl. CPC H04L 9/0858; H04L 1/0063

(57) ABSTRACT

A method for quantum key distribution between a first and a second telecommunications device connected by a quantum channel and a classical channel, includes transmitting bits by transmitting light pulses having quantum states coding the bits on the quantum channel; distributing at least certain bits of the bits of the generated sequence into 3 distinct sets of bits, each bit being associated with an index number dependent on its rank within at least the certain bits: a first set of bits for defining the secret key, a second set of bits equal to 0 and a third set of bits equal to 1; each bit of at least the second and third sets being associated, in a memory of the first device, with its index number; information received from the second device comprising a series ind1 ind2 . . . indn, where indi, i=1 to n with n≥1, indicates an index number associated with a bit in the second or third set, for each parity bit calculated by the second device on the first set: determining the value of the bit bi associated, in the memory of the first device, with the index number indi for i=1 to n, and decoding, in accordance with a determined code, the value of each parity bit on the basis of the series of bits b1 b2 . . . bn determined for the parity bit.

### CROSS-REFERENCE TO RELATED APPLICATIONS

This application is a National Stage of International patent application PCT/EP2023/070872, filed on Jul. 27, 2023, which claims priority to foreign French patent application No. FR 2207760, filed on Jul. 28, 2022, the disclosures of which are incorporated by reference in their entireties.

### FIELD OF THE INVENTION

The invention lies in the field of the generation and sharing of symmetric secret keys between two remote telecommunications devices associated with their respective users, who are called Alice and Bob below: Alice and Bob have to use a strictly identical key to be able to encrypt/decrypt their messages. The invention relates more particularly to quantum key distribution (QKD) and the underlying communication of parity information.

### BACKGROUND

Quantum cryptography is based on the transmission of qubits (quantum bits) or of randomly generated coherent states to create and distribute secret keys able to be used by classical encryption protocols such as one-time pad encryption. Since the first protocol proposed in 1984 (BB84), multiple QKD protocols have been defined. A distinction is drawn between discrete-variable protocols (qubits, DV-QKD) and continuous-variable protocols (CV-QKD). Some protocols (BB84, DV-QKD) are based on random choices of a generation and measurement base, and involve communicating these choices of base. Other protocols (CV-QKD with a heterodyne receiver) do not involve communications regarding the choice of a measurement base. Some protocols based on photon entanglement involve a photon source external to Alice and Bob. However, all QKD protocols incorporate a residual error correction step to create a key that is shared between Alice and Bob, implementing parity bit communication, for various error detection or correction techniques (FEC codes (forward error correction codes) such as LDPC (low-density parity code), interactive and iterative protocols such as Cascade or Winnow, etc.). For illustrative purposes, reference will be made below to the BB84 protocol.

In a quantum cryptography protocol, the two remote parties Alice and Bob possess:
quantum objects, that is to say tangible objects that behave in accordance with the laws of quantum physics; in practice, these objects are light pulses (photons) that may take multiple forms: single photons, coherent states, pairs of entangled photons, etc.; the photon enables encoding of information on observable variables such as light polarization, light frequency, light phase, etc.;
a quantum channel, which allows light pulses to transit;
a classical communication channel (also referred to as a public channel) (typically involving the Internet, radio waves or fiber-optic or free-space optical transmission).

Quantum key distribution (QKD) is a technique that exploits quantum properties to guarantee randomness, which makes it possible to detect the interception and retransmission of an initial message generated by Alice and intended for Bob by a malicious third party, which we will call Eve (Eavesdropper). Insofar as it is impossible to clone unknown quantum information without it being destroyed, or to measure an unknown quantum state without modifying it, the reading of qubits while they are being transmitted between two parties wishing to encrypt their communications with a secret key derived from these qubits by an intruder is able to be detected immediately: any interception will be detected immediately by Alice and Bob, who will renounce this key.

One reference QKD technique is the BB84 protocol published by C. Bennett and G. Brassard in 1984 and using discrete variables: qubits. A qubit takes a value of 0 or 1, and is represented by the polarization of a single photon, on two possible quadratures (bases): H/V or D/A (the upper-case H, V, D, A indicate the type of polarization: H for horizontal, V for vertical, D for diagonal and A for antidiagonal). The steps are then conventionally as follows.

The main steps of quantum key distribution are as follows:
Alice generates a sequence of random bits and codes each bit on each light pulse, then transmits it to Bob via the quantum channel.
Bob then measures the information carried by the pulse he has received.
Alice and Bob evaluate a level of interception of the information exchanged on the quantum channel on the basis of the differences between the transmitted data and the measured data and, if the level is higher than a fixed threshold, the quantum distribution operation is terminated.
If not, the secret key is extracted from the correlated data via what is referred to as a data reconciliation step: in this reconciliation step, a bit string shared by Alice and Bob is determined from the correlated data and an error correction algorithm implementing parity bits.
A step of amplifying the secret is generally implemented in order to neutralize information leakage during reconciliation.

For each qubit (0/1) of a series of qubits generated randomly by Alice, Alice generates, on the quantum channel, a photon whose polarization depends on the random choice of a quadrature (H/V or D/A) and the binary value under consideration (0/1).

At the other end of the quantum channel, on the reception side, Bob randomly selects, for each qubit, a quadrature to carry out the detection (either on H/V or on D/A). Any qubit measured on one and the same quadrature as the quadrature used at transmission is normally transmitted correctly: 100% to within ε. (typically, the value of ε is in the range [0; 10%]). When the Tx/Rx quadratures are not identical, the transmission has a probability of 50% to within ε of being false.

After the transmission, Bob therefore possesses a set of measurements that are correlated with the data sent by Alice, but that may have been spied on by Eve.

What is referred to as the reconciliation phase then takes place, using only the classical communication channel, where:
what is referred to as a sifting step selects the transmitted qubits for which Alice and Bob use one and the same generation and detection quadrature: to this end, Alice and Bob communicate in unencrypted form on the classical channel to broadcast the quadratures that are used; this makes it possible to create two versions of a key referred to as a sifted key, respectively on the side of Alice and Bob, by discarding on average 50% of the qubits (different Tx/Rx quadratures);
the error rate is estimated in order to determine the possible presence of Eve (case of key rejection) and to select an error correction code (choice of code and rate) or to parameterize an interactive and iterative request/response-based error correction protocol for the remainder of the processing;
a residual error detection and correction step comprising exchanges of parity bits calculated by Alice and/or Bob on their respective sifted key then takes place (Cascade or Winnow protocol, LDPC FEC error correction code, etc.), following which Alice and Bob share a strictly identical key, for which Eve possesses some information.

Alice and Bob then share a secret key (after an additional step of amplifying the secret).

The broadcasting, on the public channel, of information shared between Alice and Bob (side information) concerning the values of the parity bits, in the reconciliation phase, constitutes harmful information leakage likely to help Eve in her quest for the key. This disclosure works against the secrecy of the key, and requires processing to amplify the secret, at the expense of reducing the size of the key.

Indeed, with knowledge of the choice of the bases used for each qubit, Eve knows which qubits are reliable (to within 1-ε) out of those she has measured. Based on the reliable qubits, and with knowledge of the (reliable) parity values and the residual error correction method, Eve is able to derive values of other qubits, either in terms of value or in terms of probability. In any case, this information broadcast on the public channel makes it possible to reduce the number of combinations Eve needs to explore for the key.

There is therefore a need for a quantum key distribution solution that makes it possible to better preserve secrecy and reduce the risk of information leakage on the public channel.

### SUMMARY OF THE INVENTION

To this end, according to a first aspect, the present invention describes a method for quantum key distribution between a first and a second telecommunications device connected by a first and a second telecommunications link,
said first link being an optical transmission link and being referred to hereinafter as a quantum channel, said second remote transmission link being referred to hereinafter as a classical channel;
said method comprising the following steps, implemented by the first device:
   the first device generating a random sequence of bits;
   for each bit successively considered in the generated sequence, coding said bit at least by way of a value of a parameter defining a quantum state of a respective light pulse comprising at least one photon, said value of the parameter being determined on the basis of at least the value of said bit; a light pulse having said parameter value then being transmitted on the quantum channel and to the second device following said coding;
   at least one step out of steps j and jj below:
(j) a step j comprising at least
calculating parity bits on the basis of bits of the generated sequence; and
transmitting information relating to the calculated parity bits to the second device;
(jj) a step jj comprising at least:
receiving information from the second device and relating to parity bits calculated by said second device on the basis of the receipt, by the second device, of the light pulses transmitted by the first device; and then
detecting errors in said sequence of bits on the basis of the values of said received information relating to the parity bits;
said method being characterized in that the following steps are furthermore implemented by the first device:
   distributing at least certain bits of the bits of the generated sequence into 3 distinct sets of bits, each bit being associated with an index number dependent on its rank within at least said certain bits: a first set of bits for defining the secret key, a second set of bits equal to 0 and a third set of bits equal to 1; each bit of at least the second and third sets being associated, in a memory of the first device, with its index number;
   if step (j) is implemented, said step (j) comprises the following steps:
(j0) the parity bits are calculated on the basis of bits of the first set;
(j1) in accordance with a predetermined code, coding the value of each calculated parity bit by way of a series of bits b1 b2 . . . bn of length n greater than or equal to 1;
(j2) for each bit bi, i=1 to n: if and only if bi=0, selecting one of the bits of the second set and, if and only if bi=1, selecting one of the bits of the third set;
(j3) said transmission of information relating to the calculated parity bits comprises transmitting, on the classical channel and for each calculated parity bit, a series ind1 ind2 . . . indn, where indi, i=1 to n, indicates the index number associated with said bit selected in the second or third set in step j2 for the bit bi;
   if step (jj) is implemented, said step (jj) comprises the following steps:
(jj0) the information received from the second device comprising, for each of said parity bits, a series ind1 ind2 . . . indn, where indi, i=1 to n with n≥1, indicates an index number associated with a bit in the second or third set, for each parity bit: determining the value of the bit bi associated, in the memory of the first device, with the index number indi for i=1 to n, and decoding, in accordance with a determined code, the value of each parity bit on the basis of the series of bits b1 b2 . . . bn determined for said parity bit;
(jj1) said error detection is an error detection carried out in the first set of bits to define the secret key and is performed on the basis of said values of the parity bits thereby decoded.

The proposed solution greatly reduces information leakage and improves secrecy: the values of the parity bits for the residual error detection/correction are not transmitted on the public channel. This information is transmitted indirectly and in two stages: by transmitting a random qubit signal on the quantum channel, and then, after sifting, by transmitting the index numbers of the parity qubits on the public channel. Therefore, to know the values of the parity bits, it is necessary to possess qubits and their index number, half of the qubit values remaining inaccessible to Eve.

In some embodiments, such a method will furthermore comprise at least one of the following features:
the quantum key distribution method comprises at least one of the following provisions for step j:
   if the value of bi is 0, the transmitted information relating to bi indicates the index number of the selected bit of the second set and, if the value of bi is 1, the transmitted information relating to said bit thus indicates the index number of the selected bit of the third set; said selection being made by a draw;
the first device comprises at least two distinct coding bases between values of said parameter and the values 0 or 1 of a bit; and the first device randomly selects, for each bit under consideration in the generated sequence, one base out of the at least two distinct bases to perform said bit coding by way of said value of said light pulse parameter and stores, for each bit of the sequence, an indication of the selected base;
   after the transmission step, the first device transmitting, to the second device and on the classical channel, the indication of the base that the first device has selected for each bit of the sequence and receiving, from said second device and on the classical channel, the indication, for each bit of the sequence, of the base that said second device has selected to evaluate the value of said bit of the sequence;
   comparing, for each bit of the sequence, the stored and received base indications and identifying the bits of the sequence for which the base selected by the first device and the second device are identical;
   the first, second and third sets of bits consist of bits thereby identified.

According to another aspect, the invention describes a computer program intended to be stored in the memory of a first device and furthermore comprising a microcomputer, said computer program comprising instructions that, when they are executed on the microcomputer, orchestrate the steps of a method according to the first aspect of the invention.

According to another aspect, the invention describes a telecommunications device designed to be connected to another telecommunications device via a first and a second telecommunications link,
said first link being an optical transmission link and being referred to hereinafter as a quantum channel, said second remote transmission link being referred to hereinafter as a classical channel;
said device being designed to generate a random sequence of bits and, for each bit successively considered in the generated sequence, to code said bit at least by way of a value of a parameter defining a quantum state of a respective light pulse comprising at least one photon, said value of the parameter being determined on the basis of at least the value of said bit, and to transmit, on the quantum channel and to the other device, a light pulse having said parameter value;
said device being designed to perform at least one operation out of operations j and jj below:
   (j) an operation j comprising at least
   calculating parity bits on the basis of bits of the generated sequence; and
   transmitting information relating to the calculated parity bits to the other device;
   (j) an operation jj comprising at least:
   receiving information from the other device and relating to parity bits calculated by said other device on the basis of the receipt, by the other device, of the light pulses transmitted by the device; and then
   detecting errors in said sequence of bits on the basis of the values of said received information relating to the parity bits;
said device being characterized in that it is designed to distribute at least certain bits of the bits of the generated sequence into 3 distinct sets of bits, each bit being associated with an index number dependent on its rank within at least said certain bits: a first set of bits for defining the secret key, a second set of bits equal to 0 and a third set of bits equal to 1; each bit of at least the second and third sets being associated, in a memory of the device, with its index number;
   if the device performs operation (j), the device is designed, in said operation, to:
(j0) calculate the parity bits on the basis of bits of the first set;
(j1) code, in accordance with a predetermined code, the value of each calculated parity bit by way of a series of bits b1 b2 . . . bn of length n greater than or equal to 1;
(j2) for each bit bi, i=1 to n: if and only if bi=0, select one of the bits of the second set and, if and only if bi=1, select one of the bits of the third set;
(j3) in order to transmit the information relating to the calculated parity bits: transmit, on the classical channel and for each calculated parity bit, a series ind1 ind2 . . . indn, where indi, i=1 to n, indicates the index number associated with said bit selected in the second or third set in step j2 for the bit bi; and/or
   if the device performs operation (jj), the device is designed, in said operation, to:
(jj0) the information received from the other device comprising, for each of said parity bits, a series ind1 ind2 . . . indn, where indi, i=1 to n with n≥1, indicates an index number associated with a bit in the second or third set, for each parity bit: determine the value of the bit bi associated, in the memory of the device, with the index number indi for i=1 to n, and decode, in accordance with a determined code, the value of each parity bit on the basis of the series of bits b1 b2 . . . bn determined for said parity bit;
(j1) perform, on the basis of said values of the parity bits thereby decoded, said error detection in the first set of bits so as to define the secret key.

According to another aspect, the invention describes a method for quantum key distribution with respect to a first and a second telecommunications device each connected to a respective first telecommunications link and connected to one another via a second telecommunications link,
said first link being an optical transmission link and being referred to hereinafter as a quantum channel, said second remote transmission link being referred to hereinafter as a classical channel;
said method comprising the following steps, implemented by the second device:
   receiving a sequence of light pulses on the quantum channel such that, for each light pulse of the received sequence of pulses, a parameter of the light pulse is measured;
   for each light pulse, estimating the value of at least one bit coded by said pulse on the basis of said measurement of the parameter; the bits estimated on the basis of the light pulses of the sequence defining a sequence of bits;
   at least one step out of steps j and jj below:
(j) a step j comprising at least:
calculating parity bits on the basis of bits of said sequence; and
transmitting information relating to the calculated parity bits to the first device;
(jj) a step jj comprising at least:
receiving information from the first device and relating to parity bits calculated by said first device on the basis at least of bits corresponding to the sequence of bits; and then
detecting errors in the sequence of bits on the basis of the received information relating to the parity bits;
said method being characterized in that the following steps are furthermore implemented by the second device:
   distributing at least certain bits of the bits of the sequence into 3 distinct sets of bits, each bit being associated with an index number dependent on its rank within at least said certain bits: a first set of bits for defining the secret key, a second set of bits equal to 0 and a third set of bits equal to 1; each bit of at least the second and third sets being associated, in a memory of the second device, with its index number;
   if step (j) is implemented, said step (j) comprises the following steps:
(j0) the parity bits are calculated on the basis of bits of the first set;
(j1) in accordance with a predetermined code, coding the value of each calculated parity bit by way of a series of bits b1 b2 . . . bn of length n greater than or equal to 1;
(j2) for each bit bi, i=1 to n: if and only if bi=0, selecting one of the bits of the second set and, if and only if bi=1, selecting one of the bits of the third set;
(j3) said transmission of information relating to the calculated parity bits comprises transmitting, on the classical channel and for each calculated parity bit, a series ind1 ind2 . . . indn, where indi indicates the index number associated with said bit selected in the second or third set in step j2 for the bit bi;
   if step (jj) is implemented, said step (jj) comprises the following steps:
the information received from the first device comprising, for each of said parity bits, a series ind1 ind2 . . . indn, where indi, i=1 to n with n≥1, indicates an index number associated with a bit in the second or third set, for each parity bit: determining the value of the bit bi associated, in the memory of the second device, with the index number indi for i=1 to n, and decoding, in accordance with a determined code, the value of each parity bit on the basis of the series of bits b1 b2 . . . bn determined for said parity bit;
said error detection is an error detection carried out in the first set of bits to define the secret key and is performed on the basis of said values of the parity bits thereby decoded.

In some embodiments, such a method will furthermore comprise at least one of the following features:
the quantum key distribution method comprises one or the other of the following provisions:
   if the value of bi is 0, the transmitted information relating to bi indicates the index number of the selected bit of the second set and, if the value of bi is 1, the transmitted information relating to said bit thus indicates the index number of the selected bit of the third set; said selection being made by a draw;
the second device comprises at least two distinct correspondence bases between values of the parameter and the values 0 or 1 of an estimated bit, out of multiple distinct bases, and the second device randomly selects, for each pulse under consideration in the sequence of pulses, one base out of the at least two distinct bases to estimate the value of at least said bit on the basis of the measurement of said parameter and stores, for each bit of the sequence, which base was selected;
   after the reception step, the second device sends, to the first device and on the classical channel, the indication of the base that the second device has selected for each bit of the sequence of bits as stored and receives, from said first device and on the classical channel, the indication of the base that said first device has selected to code each bit of the sequence;
   comparing, for each bit of the sequence, the stored and received base indications and identifying the bits of the sequence for which the base selected by the first device and the second device are identical;
   the first, second and third sets of bits consist of bits thereby identified.

According to another aspect, the invention describes a computer program intended to be stored in the memory of a second device and furthermore comprising a microcomputer, said computer program comprising instructions that, when they are executed on the microcomputer, orchestrate the steps of a method according to this previous aspect of the invention.

According to another aspect, the invention describes a telecommunications device designed to be connected to a first telecommunications link and to be connected to a second telecommunications link connecting said device to another telecommunications device,
said first link being an optical transmission link and being referred to hereinafter as a quantum channel, said second remote transmission link being referred to hereinafter as a classical channel;
said device being designed to receive a sequence of light pulses on the quantum channel and, for each light pulse of the received sequence of pulses, measure a parameter of the light pulse;
said device being designed to estimate, for each light pulse, the value of at least one bit coded by said pulse on the basis of said measurement of the parameter; the bits estimated on the basis of the light pulses of the sequence defining a sequence of bits;
said device being designed to perform at least one operation out of operations j and jj below:
   (j) an operation j comprising at least:
   calculating parity bits on the basis of bits of said sequence; and
   transmitting information relating to the calculated parity bits to the other device;
(jj) an operation jj comprising at least:
   receiving information from the other device and relating to parity bits calculated by said other device on the basis at least of bits corresponding to the sequence of bits; and then
   detecting errors in the sequence of bits on the basis of the received information relating to the parity bits;
said device being characterized in that it is designed to distribute at least certain bits of the bits of the sequence into 3 distinct sets of bits, each bit being associated with an index number dependent on its rank within at least said certain bits: a first set of bits for defining the secret key, a second set of bits equal to 0 and a third set of bits equal to 1; each bit of at least the second and third sets being associated, in a memory of the device, with its index number;
   if the device performs operation (j), the device is designed, in said operation, to:
(j0) calculate the parity bits on the basis of bits of the first set;
(j1) code, in accordance with a predetermined code, the value of each calculated parity bit by way of a series of bits b1 b2 . . . bn of length n greater than or equal to 1;
(j2) for each bit bi, i=1 to n: if and only if bi=0, select one of the bits of the second set and, if and only if bi=1, select one of the bits of the third set;
(j3) in order to transmit the information relating to the calculated parity bits: transmit, on the classical channel and for each calculated parity bit, a series ind1 ind2 . . . indn, where indi indicates the index number associated with said bit selected in the second or third set in step j2 for the bit bi;
   if the device performs operation (jj), the device is designed, in said operation, to:
the information received from the other device comprising, for each of said parity bits, a series ind1 ind2 . . . indn, where indi, i=1 to n with n≥1, indicates an index number associated with a bit in the second or third set, for each parity bit: determine the value of the bit bi associated, in the memory of the device, with the index number indi for i=1 to n, and decode, in accordance with a determined code, the value of each parity bit on the basis of the series of bits b1 b2 . . . bn determined for said parity bit;
perform, on the basis of said values of the parity bits thereby decoded, said error detection in the first set of bits so as to define the secret key.

### BRIEF DESCRIPTION OF THE DRAWINGS

The invention will be better understood and other features, details and advantages will become more clearly apparent on reading the following description, which is given by way of non-limiting example, and by virtue of the appended figures, which are given by way of example.

FIG. 1 schematically shows a QKD key generation system in one embodiment of the invention;

FIG. 2 shows the steps of a quantum key distribution method in one embodiment of the invention;

FIG. 3 illustrates the transmission and detection of a sequence of qubits in one embodiment of the invention;

FIG. 4 shows one example of partitioning the random sequence of qubits into three sets, performed in D_ALICE and D_BOB.

Identical references may be used in different figures to designate identical or comparable elements.

### DETAILED DESCRIPTION

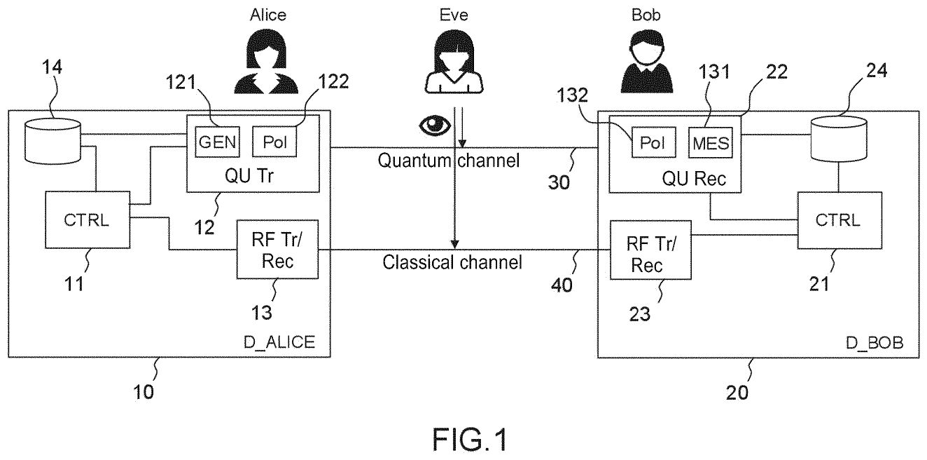

FIG. 1 shows a QKD symmetric key generation system in one embodiment of the invention, comprising two telecommunications devices 10, 20 connected to one another by a quantum channel 30 and a classical channel 40. Each or one of the telecommunications devices 10, 20 is for example on the ground, or on board a satellite, an aircraft, etc.

The quantum channel 30 is a telecommunications channel that allows information (binary in DV-QKD or continuous in CV-QKD) carried by a property of a quantum object (for example polarization of a photon) transmitted on this channel to transit; here, the quantum channel 30 is designed to transmit light pulses (a fiber-optic optical link or simply one implemented by a directional photon source in open air, the atmosphere, space, etc.).

The classical channel 40 is a standard communication channel, for example (for example a radiofrequency link, the Internet, an optical fiber, etc.), assumed to be accessible in unencrypted form to all (including a malicious third party Eve), so as to allow the telecommunications devices 10 and 20 to converge on the definition of a secret key on the basis of transmitted qubits, as described below for the BB84 protocol.

The telecommunications device 10, hereinafter called D_ALICE, belonging to the user Alice, comprises a control block 11, a quantum transmission block 12, a radiofrequency (RF) transmission/reception block 13 and a memory 14.

The telecommunications device 20, hereinafter called D_BOB, belonging to the user Bob, comprises a control block 21, a quantum reception block 22, a radiofrequency (RF) transmission/reception block 23 and a memory 24.

The radiofrequency (RF) transmission/reception blocks 13 and 23 are designed to communicate with one another via the classical channel 40.

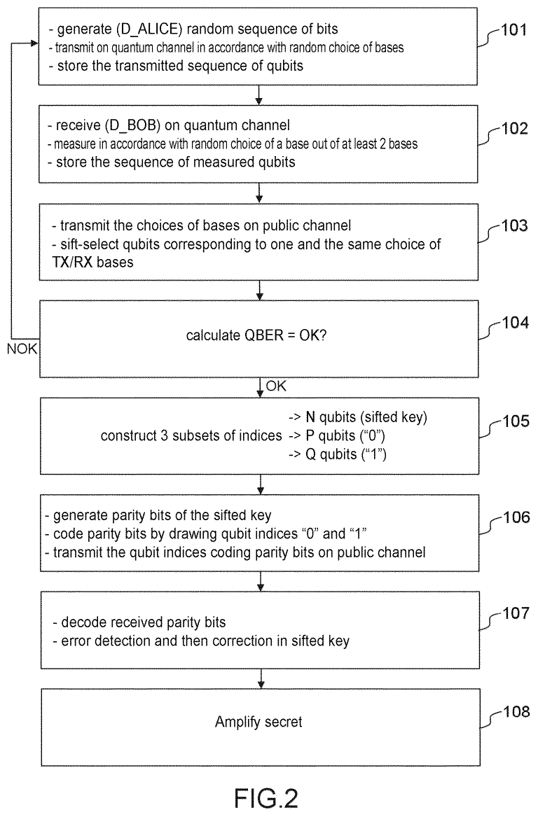

The control block 11, respectively 21, comprises for example a memory and a microprocessor (which are not shown). In one embodiment, the memory of the control block 11, respectively 21, comprises software instructions that, when they are executed on the microprocessor of the control block 11, respectively 21, implement the steps incumbent on the control block 11, respectively 21, and described below, notably with reference to FIG. 2.

The radiofrequency (RF) transmission/reception block 13, respectively 23, typically comprises a modem and a radiofrequency transmission and reception antenna (which are not shown).

The quantum transmission block 12 comprises a generation block, called GEN 121, and a polarization block, called Pol 122.

The block GEN 121 is designed to randomly generate a sequence of bits to be transmitted.

The block Pol 122 is designed to randomly choose, for each bit to be transmitted, one base out of multiple reference polarization bases (these bases are also called modes or quadratures) and to transmit a light pulse with a polarization corresponding to the value of the bit to be transmitted in the base randomly chosen for this bit.

The block Pol 122 comprises for example a polarization rotator able to pivot the polarization of the transmitted light signal selectively by 0° (if the H/V base is chosen by the block Pol 132) or by 45° (if the D/A base is chosen), the selection between 0° and 45° being made randomly. For example, the polarization rotator is produced with a half-wave retardation plate rotated by an actuator.

The bases, in this case, comprise for example:
a first horizontal/vertical (H/V) base in which “1” is coded by a photon with a polarization axis of 0° and “0” is coded by a photon with a polarization of 90°;
a second diagonal/antidiagonal (D/A) base in which “0” is coded by a photon with a polarization axis of 45° and “1” is coded by a photon with a polarization of 135°.

The quantum reception block 22 comprises a polarization block, called Pol 132, and a measuring block 131.

Before the expected arrival of a photon, the block Pol 132 is designed to carry out a polarization rotation in order to randomly choose a base out of the two bases H/V and D/A. The block Pol 132 comprises a polarization rotator able to pivot the polarization of the transmitted light signal selectively by 0° (if the H/V base is chosen by the block Pol 132) or by 45° (if the D/A base is chosen). For example, the polarization rotator is produced with a half-wave retardation plate rotated by an actuator.

The measuring block 131 is designed to measure two light components in quadrature at the output of the polarization rotator Pol 132, either on the H/V base if the polarization rotation is 0°, or on the D/A base if the polarization rotation is 45°. For example, the measuring block is formed with a polarizing beam splitter (PBS) generating a quadrature, and two photon detectors (SPD) for the two components of the quadrature.

It will be recalled here that a photon may be polarized along any axis. A photon polarized along an axis of angle ‘a’ passing through a polarizing filter along an axis of angle ‘b’ has a probability equal to cos²(b−a) of passing through the polarizing filter, according to Malus' law.

Based on the quantum properties used by quantum cryptography:
when the probability of passing through the filter is neither 0 nor 1, the passage of an individual photon through the filter is fundamentally unpredictable and indeterministic;
the only way of knowing the polarization axis is by using a polarizing filter (or more generally by carrying out a measurement the result of which is YES or NO) and with a large number of measurements to estimate the probability of passage; there is no direct measurement giving an angle for example of the polarization axis of the photon;
it is not possible to know the initial polarization axis of the photon unless the axis of the filter is oriented precisely at 0° or 90° with respect to that of the photon. In the event of another orientation of the filter (45° for example), there is fundamentally no way of knowing what the initial polarization axis of the photon was.

The steps of a QKD method are now described with reference to FIG. 2.

The starting context is as follows: Alice wishes to share a secret key with Bob in order to enable them to carry out encrypted transmissions with maximum security. For her part, Eve attempts to intercept the communications in order to determine the key. In accordance with Kerckhoff's principles (worst-case scenario), it will be assumed for example that Eve has access to the communication channels used by Alice and Bob, that she knows perfectly the protocol used and possesses unlimited computational means. The security of the encrypted communications between Alice and Bob is then provided solely by the secret key that the method described below ends up generating and distributing.

### Quantum Phase

Generally speaking, only this phase uses the quantum channel, and the post-processing phase does not use it.

### Step 101

In this step 101:
in response to a corresponding command from the control block 11 to the block GEN 121, the block GEN 121 randomly generates a sequence of NO qubits, which therefore take the value 0 or 1;
following the receipt of a respective command from the control block 11 at the block Pol 122, the block Pol 122 randomly chooses, for each bit generated, a polarization base out of the two polarization bases and transmits, on the quantum channel 30, photon by photon, a photon whose polarization depends on the value of the bit generated and on the polarization base chosen for this qubit; each photon is transmitted at regular intervals. The qubits are thus transmitted.

The generated sequence of qubits is then stored by the control block 11 in the memory 14, and the value of each bit is stored there in association with the rank of the bit in the sequence and with the polarization base chosen for the bit by the block Pol 122.

### Step 102

Under the control of the control block 21, before the expected arrival of each photon, the block Pol 132 randomly chooses a base (by positioning the rotator randomly). At the expected time of arrival of a photon, under the control of the control block 21, the measuring block 131 measures what is leaving the filter on the selected components. The control block 21 determines the value of the qubit corresponding to the received photon on the basis of the measurement performed and of the base chosen for the measurement (corresponding to the orientation chosen for the filter by the polarizing filter block 132) and stores, in the memory 24, for each received photon, the determined value of the qubit in association with the reception rank of the photon (and therefore of the qubit) and the chosen base.

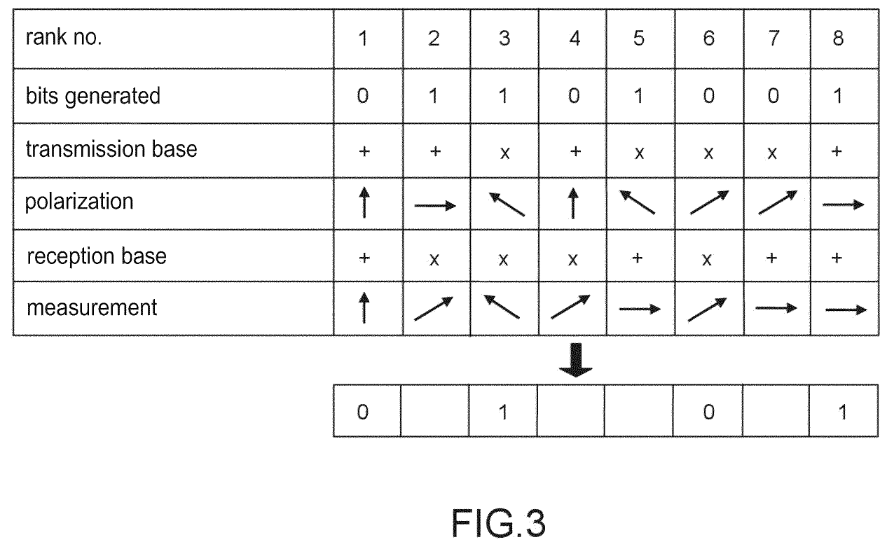

FIG. 3 shows, in a table, the rank number of the first 8 bits of a sequence generated in step 101 (first row of the table) and the value randomly generated for these bits (second row). These bits thus take the following values: 0 for the bit of rank 1, 4, 6 and 7, and 1 for the bit of rank 2, 3, 5 and 8.

The third row indicates the base chosen for the transmission of each bit by the device D_ALICE 10: the sign “+” indicates that the H/V base has been chosen, while the sign “x” indicates that the D/A base has been chosen. Thus, for the bits of rank 1, 2, 4 and 8, the H/V base has been chosen, and the D/A base has been chosen for the bits of rank 3 and 5 to 7.

The 4^{th} row indicates the polarization of the transmitted photon: vertical for the bit of rank 1 and 4, horizontal for the bit of rank 2 and 8, diagonal for the bit of rank 6 and 7, and antidiagonal for the bits of rank 3 and 5.

The fifth row of the table indicates the base chosen by the device D_BOB 20, at reception: H/V for the received photon of rank 1, 5, 7 and 8, and DIA for the photon of rank 2, 3, 4 and 6.

Finally, the sixth row illustrates the result of the measurement by the device D_BOB 20: for the photons of rank 1, 3, 6, 8, the measurement base corresponds to the transmission base and the polarization of the detected photon corresponds in general to the polarization at transmission of the photon; for the photons of rank 2, 4, 5, 7, the measurement base is different from the transmission base and the polarization of the detected photon is completely random. The determined value of the qubit stored in the memory 24 is 0 for the photon of rank 1 and 6 and is 1 for the photon of rank 3 and 8.

### Post-Processing Phase

### Step 103 (Sifting)

In a step 103:
the controller 11 of the device D_ALICE 10 indicates to the device D_BOB 20, via the RF transmission/reception block 13, by way of a message transmitted on the classical channel 40, the polarization base chosen for each qubit of the sequence transmitted in step 101;
the controller 21 of the device D_BOB indicates to the device D_ALICE, via the RF transmission/reception block 23, by way of a message transmitted on the classical channel 40, the polarization base chosen for each photon of the sequence received in step 102;
each controller 11, respectively 21, then compares, for each rank in the sequence, the chosen polarization base received on the classical channel 40 and the polarization base associated with this rank and that is stored in the memory of the device 10, respectively 20; it selectively retains (sifting step) only the qubits generated (D_ALICE 10) and measured (D_BOB 20) on one and the same base. Statistically, only 50% of the bits are retained.

All of these retained qubits were transmitted to Bob with a probability of 1-8, that is to say to within errors induced by noise, adjustment/synchronization defects and implementation imperfections. Sifting has made it possible to discard qubits that were detected on a base other than the generation base, these qubits being unreliable (at 50%: therefore random). Each qubit that is retained is identified by its rank in the sequence transmitted by D_ALICE/received by D_BOB.

In the example in FIG. 3, the bits of rank 1, 3, 6 and 8 are thus the only ones retained out of the first eight bits of the sequence for the remainder of the steps.

### Step 104

The control blocks 11 and 21 then evaluate the quantum bit error rate (QBER) separating their respective sets of bits retained in sifting step 103, in order to detect potential interception by Eve, to evaluate the amount of information intercepted by Eve on the quantum channel during transmission in step 101 and possibly to select, on the basis of the evaluated error rate, an error correction code (choice of code and rate) or to parameterize an iterative request/response-based error correction protocol for the remainder of the processing. To this end, a certain number of qubits are “sacrificed” since they are communicated on the classical channel 40: they are also discarded from the bits retained by the control blocks 11 and 21 for the remainder of the post-processing.

Depending on the comparison between this evaluation of the error rate and a given threshold (determining whether a third party was listening to the quantum channel during the transmission of the qubits), the present distribution operation is terminated (and may then be reinitiated starting from step 101); otherwise, step 105 is implemented.

### Step 105

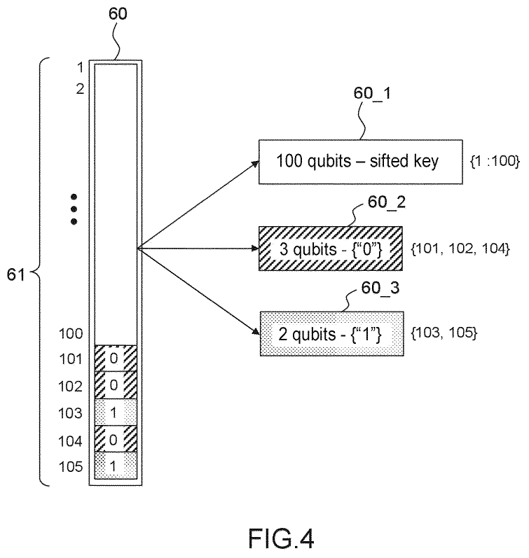

In this step 105, with reference to FIG. 4, each control block 11, respectively 21, in parallel with one another, partitions the M qubits resulting from the sifting 103 and retained at the end of step 104 into three sets, in accordance with a common and predefined partition rule:
a set 60_1 of N qubits, intended to form the sifted key respectively for Alice and Bob (the partition rule defines them for example as the N bits having the lowest rank, or else having the highest rank);
and the remaining M-N qubits are distributed into two sets: a set 60_2 of qubits of value 0 and a set of qubits 60_3 of bits of value 1.

The control block 11, 21 stores in memory 14, 24, for each of the M bits, an indication of the set 60_1, 60_2 or 60_3 to which this bit has been assigned, in association with the value of the bit.

The set 60_2 of bits of value 0 comprises P bits and the set of bits 60_3 of bits of value 1 comprises Q bits. Random generation is assumed to produce ‘0’s and ‘1’s independently and with equal probability. For a relatively large value of M−N, for example greater than 20, in general P≈Q.

In the example shown in FIG. 3, M=105, N=100, P=3 and Q=2.

The list 61 of index numbers in FIG. 4 indicates the index number associated with each of the M qubits. According to the embodiments, the index number is equal to the rank (that is to say order number) of the qubit in the transmitted/received sequence (before sifting), or is equal to the rank of the qubit in the M qubits retained (after sifting) out of the NO bits transmitted or, more generally, determined on the basis of such a rank of the qubit out of the qubits. Notably, if the index number is different from the rank, the control block 11, 21 also stores in memory 14, 24, for each of the M bits, the index number associated with this bit. The rule for defining the index number is of course common to the devices D_ALICE 10 and D_BOB 20 and is predefined.

In the example of FIG. 4:
the index numbers of the qubits assigned to the set 60_2 of qubits equal to 0 are: 101, 102 and 104, whereas the index numbers of the qubits assigned to the set 60_3 of qubits equal to 1 are: 103, 105;
the sifted key is defined by the series of qubits associated with the index numbers 1 to 100.

The qubits of the sets 60_2 and 60_3 are intended to carry, later and optionally, parity information as will be described below: indeed, only some of them will actually be used a priori, these being chosen on the basis of the parity values that will have to be transmitted between the devices 10 and 20.

Due to the limitations of photon sources and photon detectors, implementation imperfections, adjustment imperfections or synchronization imperfections, the N bits of the sifted key that are retained at this stage by D_ALICE and D_BOB are not generally perfectly identical. Step 106 below of the reconciliation phase aims to detect/correct residual errors of the N qubits of the sifted key determined respectively by D_ALICE and D_BOB, using a forward error correction (FEC) code, or else an interactive and iterative request/response protocol between Alice and Bob, to determine and transmit parity bits associated with subgroups (that is to say packets) of the N qubits of the sifted key, in order to detect/correct residual errors between Alice's key and Bob's key and so that they then possess a strictly identical key.

Redundant parity information is then generated either by D_ALICE 10 or by D_BOB 20 or by both.

As described below, these parities are transmitted (indirectly via the public channel and the quantum channel) to the other party, so that said other party is able to identify residual errors on one sifted key relative to the other (Alice/Bob), in accordance with the adopted error detection and correction protocol, on the basis of the received parities and their own sifted key.

### Step 106

In one embodiment, in a step 106, each control block 11, 21, in parallel with one another, calculates parity bits from subgroups of the N bits of the sifted key in step 105, on the basis of the adopted error detection and correction protocol (here a Cascade or Winnow iterative protocol) (the value of the parity bits is therefore not dependent on the bits of the sets 60_2 and 60_3).

The values of the parity bits as calculated by each control block 11, respectively 21, are stored in memory 14, 24.

In order to inform D_ALICE 10, respectively D_BOB 20, of the values of the calculated parity bits, the control block 21, respectively 11, does not transmit the values of these parity bits on the classical channel 40, but instead it transmits, on the classical channel 40, the index numbers of qubits selected from the sets 60_2 and 60_3 that code the value of the parity bits.

For example, for each parity bit under consideration, the control block 11, respectively 21, if the parity bit is equal to 0, selects (for example randomly) a bit from the set 60_2, and transmits, on the classical channel to D_BOB 20, respectively D_ALICE 10, the index number (101, 102 or 104 in the case of FIG. 4) associated with the selected bit to indicate the value of the parity bit under consideration (the chosen QKD protocol defines the bits of the sifted key on the basis of which the parity bit was calculated). If the parity bit is equal to 1, a bit of the set 60_3 is selected (for example randomly), and the control block 11, respectively 21, transmits, on the classical channel to D_BOB 20, respectively D_ALICE 10, the index number (103 or 105) associated with the selected bit to indicate the value of the parity bit under consideration.

### Step 107

In one embodiment, in a step 107, each control block 11, 21, in parallel with one another, receives, on the classical channel, a message containing the bit index number of one of the sets 60_2 and/or 60_3 that codes the parity bit for a subgroup of bits of the sifted key 60_1; it retrieves, from its memory 14, 24, the value 0 or 1 of the bit associated with the received index number. It then compares it with the value of the parity bit that it calculated itself for this same subgroup of bits. Residual errors between the sifted key 60_1 held by D_ALICE 10 and D_BOB 20 may thus be detected and corrected on the basis of this comparison performed for each parity bit. This process makes it possible to obtain, in D_ALICE and D_BOB, a strictly identical secret key that is shared between Alice and Bob.

A Cascade or Winnow iterative protocol involves a variable number of requests/responses between D_ALICE 10 and D_BOB 20, depending on the number of residual errors; a forward error correction (FEC) code involves a single message sent by one of the devices 10, 20 to detect/correct residual errors. Exchanges take place on the public channel 40.

Steps 106, 107 above describe, by way of example, the case of a Cascade or Winnow iterative protocol (calculation of parity bits in the devices 10, 20, transmission by each device to the other, comparison in each device).

In the case of using an LDPC FEC code protocol, according to the embodiments:
the control block D_Alice 11 calculates for example the parity bits from the bits of Alice's sifted key; these parities are transmitted to the control block 21 of D_BOB 20, which decodes them with its sifted key version in order to identify errors on its key (Bob); next, D_Bob corrects its errors (in one particular embodiment, there is no calculation of parity bits by D_BOB, nor any comparison between parity bits that it may have received and others that it may have calculated on the basis of its sifted key); and/or
the control block of D_BOB 21 calculates for example the parity bits from the bits of Bob's sifted key; these parities are transmitted to the control block 11 of D_ALICE 10, which decodes them with its sifted key version in order to identify errors on its key (Alice); next, D_ALICE corrects its errors (in one particular embodiment, there is no calculation of parity bits by D_ALICE, nor any comparison between parity bits that it may have received and others that it may have calculated on the basis of its sifted key).

Regardless of the adopted error detection and correction protocol, the principle remains the same: transmitting, to the other device, information for accessing the parity values on the public channel by transmitting the indices of the qubits of the sets 60_2 and 60_3 (neither the values of these qubits nor the values of the parity bits being transmitted on the public channel).

### Step 108

A step of amplifying the secret implements hash functions to combine the bits of the key obtained at the end of step 107 and thus reduce Eve's information about the final key, at the expense of reducing the size of the key. Hash functions are very difficult to reverse, with a chaotic behavior, and may be used to generate pseudo-random numbers. They often use modular arithmetic.

Example of a hash function:

$$The original proposition by Carter and Wegman ( 1 ) was to choose a prime value of p , p \geq IUI and to define$$

$$h \text{?} ( \text{?} ) = ( \text{?} + \text{?} ) mod p ) mod m$$

$$\text{?} \text{indicates text missing or illegible when filed}$$

At the end of step 108, Alice and Bob possess a shared secret key, which they then each use as a symmetric encryption key to code and decode messages exchanged between them on the public channel or another channel.

### Variant: Multiple Qubits to Code a Parity Bit

One variant consists, in step 106, in using multiple qubits (and not just one) to code the value of a parity bit. This makes it possible to aid Alice/Bob in the creation of a shared key, and penalize Eve in the quest for this key. Such a variant makes it possible to use soft-decision error correction codes (which are more efficient) and to dilute the reliability of the 50% of parity bits accessible to Eve.

In such a variant, in the control block 11, 21 of the telecommunications device D_ALICE/D_BOB, the values of the parity bits are determined using a known coding technique: FEC correction codes, for example soft-decision (soft decoding) FEC correction codes such as an LDPC FEC code, (Cascade or Winnow) iterative protocols. For each parity bit to be transmitted, the control block 11, 21 uses a code to represent the binary value with a group of t bits carried by t qubits.

For example, a repetition code on 3 bits (3 qubits associated with one and the same binary value, but not necessarily one and the same base) may be used to represent a parity bit. The likelihood LLR (logarithmic likelihood ratio) of the value of the bit thus coded is then the sum of the LLR of the binary values of the 3 qubits.

$$L L R ( b ) = \frac{log ( P ( b = 0 ) )}{log ( P ( b = 1 ) )}$$

$$LL {R}_{parity bit} = {\sum }_{i = 1}^{3} L L {R}_{bit qubit ( i )}$$

This makes it possible to filter infrequent transmission/detection error cases (if 1 qubit is transmitted incorrectly, the other 2 are sufficient to compensate for this, such that the detection is correct on the group of 3 qubits). The control block 11, 21 transmits the indices of all of the parity support qubits. For this example, this is three times as many parity support qubits. The recipient block 21, 11 receives these indices and then, for each parity bit, accesses in memory 14, 24 the values of the t qubits associated with these indices and proceeds with decoding to determine a probability of the binary value. For example, with the three-bit repetition code, a weighted sum of the binary values of the three qubits is used. This makes it possible to quantify more finely the likelihood of the binary value, and to reduce the quantum bit error rate (ε). The recipient control block 21, 11 then implements a soft-decision decoding algorithm (for this example: LDPC), using quantified probabilities at input.

Before sifting, qubits are transmitted with a typical error rate of 50%. After sifting, the qubits that are retained are assigned an error rate ε (typically a few %). After sifting, the likelihood of the value of a parity bit is enhanced (statistically on average) when multiple (t) qubits are used to carry/code this value. This is tantamount to using a correction code for each parity bit, or to reducing the error rate ε. This likelihood is then no longer constant (probability of 1-ε with a single qubit/parity bit), but is variable according to the implementations of the p qubits. It is then advantageous to use soft-decision decoding techniques (for example LDPC codes), which are more efficient than hard-decision (binary) decoding solutions.

Moreover, knowing that 50% of the qubits measured by Eve are not reliable (reliability of 50%: comparable to random noise), the combination of multiple qubits to represent a parity bit leads to dilution of the reliability of the parity bits for Eve.

According to the invention, the information for the parities is transmitted indirectly and successively via the quantum channel, and then via the public channel: the random qubits used as a reserve to code the parities are transmitted on the quantum channel, as a potential medium for indefinite information; after sifting, the qubits that are retained may be used to carry information and the public channel is then used to transmit indices of qubits carrying the parity information. The recipient determines the parity information from the receipt of these indices, which it uses as an address for the values of qubits (received beforehand on the quantum channel) stored in memory 14, 24. The parity values are therefore transmitted indirectly by an address on the public channel.

Eve is able to access the index information of the qubits corresponding to the parity bits, but she is not able to access the respective values of all of these qubits transmitted on the quantum channel. Eve may typically know 50% of the values of the qubits. The parity values are obtained, for Alice and Bob, by accessing the qubits carrying the parity information via their indices. Alice and Bob, having previously carried out sifting, are able to access the correct values with a probability of 1-ε. On the other hand, Eve is able to access 50% of the correct parity values with a probability of 1-ε, the remaining values (half) being completely undefined (0 or 1 with a likelihood of 50%).

As described, multiple qubits may be used to carry the information of a parity bit, to increase the probability of detection of a correct value by Alice and Bob, and to degrade the reliability of estimation of parity bits by Eve (the 50% of correctly received qubits will be combined with uncertain qubits).

Generally speaking, all QKD protocols have the common property of implementing reconciliation and error correction processing operations to generate two identical keys from raw keys (qubits transmitted on the quantum channel). The invention proposed here is applicable to all QKD protocols, independently of the coding mode (for example polarization coding/phase coding/etc.) and variants of these protocols.

The invention has notably been described above with reference to implementing the transmission of random binary information through the random polarization of photons, for example within the framework of the BB84 protocol; the invention is however applicable to any QKD symmetric key generation protocol (for example E91, B92, etc.) and system, including discrete-variable QKD protocols, with other quantum parameters used to code bits, for example the frequency or phase of a photon, optionally differentially (frequency-coded QKD or phase-coded QKD or differential phase-coded QKD; in the case of using phase, the coding is based on a phase modulator instead of a polarization rotator/modulator) instead of or in addition to photon polarization, protocols (GG02) using continuous variables, and/or using the transmission of multiple photons per bit, etc.

Similarly, although an example of coding a single bit per photon has been considered above, the invention also applies in the case where a parameter of the photon transmitted on the quantum channel codes multiple bits, on the basis for example of protocols that make it possible to code multiple bits per light pulse, such as the GG02, GMCS Gaussian modulated coherent state protocols.

Moreover, the invention may also be implemented in embodiments without a random choice of base used at reception and/or at transmission, such as for example in a QKD differential phase-coded protocol; the residual error correction step is then nevertheless still necessary.

The invention may also be implemented in embodiments where the QKD protocol that is employed uses photon polarization to code bits, but with a number of states considered different from the four states considered in BB84: for example, BB92 uses 2 polarizations, SSP uses 6 thereof.

The steps incumbent on the control block 11, 21 described above may be implemented by executing software instructions on a processor. As an alternative, they may be implemented by dedicated hardware, typically a digital integrated circuit that is either specific (ASIC) or based on programmable logic (for example FPGA/field-programmable gate array).

The term “bit” designates the binary information itself (“0” or “1”), and the term “qubit” more specifically designates this binary information when it is carried by a quantum state of an elementary particle, in particular a photon (that is to say generation and polarization in the device 10, propagation in the quantum channel and measurement in the device 20); however, in the above description, one or the other of the two terms may have been used indiscriminately to designate the corresponding binary information.

It should be noted that the random choice of the polarization base, both at transmission and at reception, may be made in various ways: as described below, with a polarization rotator and beam splitter, or else through mechanical switching of a polarization rotator, etc. according to known techniques.

Moreover, in some embodiments, the QKD protocol that is implemented is based on entanglement (for example E91 protocol) in which photons are generated by a source that may be external to Alice and Bob. In this case, Alice does not generate the binary sequence: Alice and Bob receive this sequence and are like 2 receivers that agree with one another on the decoding of the sequence of qubits received, with random choices of base (A and B), in accordance with steps 103 (notably for sifting) et seq. described above.

1. A method for quantum secret key distribution between a first and a second telecommunications device (D_ALICE, D_BOB) connected by a first and a second telecommunications link,
said first link (30) being an optical transmission link and being a quantum channel, said second remote transmission link being a classical channel (40);
said method comprising the following steps, implemented by the first device (D_ALICE):
the first device generating a random sequence of bits;
for each bit successively considered in the generated sequence, coding said bit at least by way of a value of a parameter defining a quantum state of a respective light pulse comprising at least one photon, said value of the parameter being determined on the basis of at least the value of said bit; a light pulse having said parameter value then being transmitted on the quantum channel and to the second device following said coding;
at least one step out of steps j and jj below:
a step j comprising at least
calculating parity bits on the basis of bits of the generated sequence; and
transmitting information relating to the calculated parity bits to the second device;
a step jj comprising at least:
receiving information from the second device and relating to parity bits calculated by said second device on the basis of the receipt, by the second device, of the light pulses transmitted by the first device; and then
detecting errors in said sequence of bits on the basis of the values of said received information relating to the parity bits;
wherein the following steps are furthermore implemented by the first device (D_ALICE):
distributing at least certain bits of the bits of the generated sequence into 3 distinct sets of bits, each bit being associated with an index number dependent on its rank within at least said certain bits: a first set of bits for defining the secret key, a second set of bits equal to 0 and a third set of bits equal to 1; each bit of at least the second and third sets being associated, in a memory of the first device, with its index number;
if step j is implemented, said step j comprises the following steps:
(j0) the parity bits are calculated on the basis of bits of the first set;
(j1) in accordance with a predetermined code, coding the value of each calculated parity bit by way of a series of bits b1 b2 . . . bn of length n greater than or equal to 1;
(j2) for each bit bi, i=1 to n: if and only if bi=0, selecting one of the bits of the second set and, if and only if bi=1, selecting one of the bits of the third set;
(j3) said transmission of information relating to the calculated parity bits comprises transmitting, on the classical channel and for each calculated parity bit, a series ind1 ind2 . . . indn, where indi, i=1 to n, indicates the index number associated with said bit selected in the second or third set in step j2 for the bit bi;
if step jj is implemented, said step jj comprises the following steps:
jj0/the information received from the second device comprising, for each of said parity bits, a series ind1 ind2 . . . indn, where indi, i=1 to n with n≥1,indicates an index number associated with a bit in the second or third set, for each parity bit: determining the value of the bit bi associated, in the memory of the first device, with the index number indi for i=1 to n, and decoding, in accordance with a determined code, the value of each parity bit on the basis of the series of bits b1 b2 . . . bn determined for said parity bit;
jj 1/said error detection is an error detection carried out in the first set of bits to define the secret key and is performed on the basis of said values of the parity bits thereby decoded.

2. The method for quantum secret key distribution as claimed in claim 1, wherein:
if the value of bi is 0, the transmitted information relating to bi indicates the index number of the selected bit of the second set and, if the value of bi is 1, the transmitted information relating to said bit thus indicates the index number of the selected bit of the third set; said selection being made by a draw.

3. The method for quantum secret key distribution as claimed in claim 1, wherein:
the first device (D_ALICE) comprises at least two distinct coding bases between values of said parameter and the values 0 or 1 of a bit;
the first device (D_ALICE) randomly selects, for each bit under consideration in the generated sequence, one base out of the at least two distinct bases to perform said bit coding by way of said value of said light pulse parameter and stores, for each bit of the sequence, an indication of the selected base;
after the transmission of a light pulse, the first device (D_ALICE) transmitting, to the second device (D_BOB) and on the classical channel, the indication of the base that the first device (D_ALICE) has selected for each bit of the sequence and receiving, from said second device (D_BOB) and on the classical channel, the indication, for each bit of the sequence, of the base that said second device (D_BOB) has selected to evaluate the value of said bit of the sequence;
comparing, for each bit of the sequence, the stored and received base indications and identifying the bits of the sequence for which the base selected by the first device and the second device are identical;
the first, second and third sets of bits consist of bits thereby identified.

4. A computer program intended to be stored in the memory of a first device and furthermore comprising a microcomputer, said computer program comprising instructions that, when they are executed on the microcomputer, orchestrate the steps of a method as claimed in claim 1.

5. A telecommunications device (D_ALICE) designed to be connected to another telecommunications device (D_BOB) via a first and a second telecommunications link,
said first link (30) being an optical transmission link and being referred to hereinafter as a quantum channel, said second remote transmission link being referred to hereinafter as a classical channel (40);
said device (D_ALICE) being designed to generate a random sequence of bits and, for each bit successively considered in the generated sequence, to code said bit at least by way of a value of a parameter defining a quantum state of a respective light pulse comprising at least one photon, said value of the parameter being determined on the basis of at least the value of said bit, and to transmit, on the quantum channel and to the other device, a light pulse having said parameter value;
said device (D_ALICE) being designed to perform at least one operation out of operations j and jj below:
an operation j comprising at least
calculating parity bits on the basis of bits of the generated sequence; and
transmitting information relating to the calculated parity bits to the other device;
an operation jj comprising at least:
receiving information from the other device and relating to parity bits calculated by said other device on the basis of the receipt, by the other device, of the light pulses transmitted by the device; and then
detecting errors in said sequence of bits on the basis of the values of said received information relating to the parity bits;
wherein said device (D_ALICE) is designed to distribute at least certain bits of the bits of the generated sequence into 3 distinct sets of bits, each bit being associated with an index number dependent on its rank within at least said certain bits: a first set of bits for defining a secret key, a second set of bits equal to 0 and a third set of bits equal to 1; each bit of at least the second and third sets being associated, in a memory of the device, with its index number;
if the device performs operation j, the device is designed, in said operation, to:
j0/calculate the parity bits on the basis of bits of the first set;
j1/code, in accordance with a predetermined code, the value of each calculated parity bit by way of a series of bits b1 b2 . . . bn of length n greater than or equal to 1;
j2/for each bit bi, i=1 to n: if and only if bi=0, select one of the bits of the second set and, if and only if bi=1, select one of the bits of the third set;
j3/in order to transmit the information relating to the calculated parity bits: transmit, on the classical channel and for each calculated parity bit, a series ind1 ind2 . . . indn, where indi, i=1 to n, indicates the index number associated with said bit selected in the second or third set in step j2 for the bit bi; and/or if the device performs operation jj, the device is designed, in said operation, to:
jj0/the information received from the other device comprising, for each of said parity bits, a series ind1 ind2 . . . indn, where indi, i=1 to n with n≥1,indicates an index number associated with a bit in the second or third set, for each parity bit: determine the value of the bit bi associated, in the memory of the device, with the index number indi for i=1 to n, and decode, in accordance with a determined code, the value of each parity bit on the basis of the series of bits b1 b2 . . . bn determined for said parity bit;
jj 1/perform, on the basis of said values of the parity bits thereby decoded, said error detection in the first set of bits so as to define the secret key.

6. A method for quantum secret key distribution with respect to a first and a second telecommunications device (D_ALICE, D_BOB) each connected to a respective first telecommunications link and connected to one another via a second telecommunications link,
said first link being an optical transmission link and being referred to hereinafter as a quantum channel, said second remote transmission link being referred to hereinafter as a classical channel;
said method comprising the following steps, implemented by the second device (D_BOB):
receiving a sequence of light pulses on the quantum channel such that, for each light pulse of the received sequence of pulses, a parameter of the light pulse is measured;
for each light pulse, estimating the value of at least one bit coded by said pulse on the basis of said measurement of the parameter; the bits estimated on the basis of the light pulses of the sequence defining a sequence of bits;
at least one step out of steps j and jj below:
a step j comprising at least:
calculating parity bits on the basis of bits of said sequence; and
transmitting information relating to the calculated parity bits to the first device (D_ALICE);
a step jj comprising at least:
receiving information from the first device and relating to parity bits calculated by said first device; and then
detecting errors in the sequence of bits on the basis of the received information relating to the parity bits;
wherein the following steps are furthermore implemented by the second device (D_BOB):
distributing at least certain bits of the bits of the sequence into 3 distinct sets of bits, each bit being associated with an index number dependent on its rank within at least said certain bits: a first set of bits for defining the secret key, a second set of bits equal to 0 and a third set of bits equal to 1; each bit of at least the second and third sets being associated, in a memory of the second device, with its index number;
if step j is implemented, said step j comprises the following steps:
j0/the parity bits are calculated on the basis of bits of the first set;
j1/in accordance with a predetermined code, coding the value of each calculated parity bit by way of a series of bits b1 b2 . . . bn of length n greater than or equal to 1;
j2/for each bit bi, i=1 to n: if and only if bi=0, selecting one of the bits of the second set and, if and only if bi=1, selecting one of the bits of the third set;
j3/said transmission of information relating to the calculated parity bits comprises transmitting, on the classical channel and for each calculated parity bit, a series ind1 ind2 . . . indn, where indi indicates the index number associated with said bit selected in the second or third set in step j2 for the bit bi;
if step jj is implemented, said step jj comprises the following steps:
the information received from the first device comprising, for each of said parity bits, a series ind1 ind2 . . . indn, where indi, i=1 to n with n≥1, indicates an index number associated with a bit in the second or third set, for each parity bit: determining the value of the bit bi associated, in the memory of the second device, with the index number indi for i=1 to n, and decoding, in accordance with a determined code, the value of each parity bit on the basis of the series of bits b1 b2 . . . bn determined for said parity bit;
said error detection is an error detection carried out in the first set of bits to define the secret key and is performed on the basis of said values of the parity bits thereby decoded.

7. The method for quantum secret key distribution as claimed in claim 6, wherein: if the value of bi is 0, the transmitted information relating to bi indicates the index number of the selected bit of the second set and, if the value of bi is 1, the transmitted information relating to said bit thus indicates the index number of the selected bit of the third set; said selection being made by a draw.

8. The method for quantum secret key distribution as claimed in claim 6, wherein:
the second device (D_BOB) comprises at least two distinct correspondence bases between values of the parameter and the values 0 or 1 of an estimated bit, out of multiple distinct bases, and the second device (D_BOB) randomly selects, for each pulse under consideration in the sequence of pulses, one base out of the at least two distinct bases to estimate the value of at least said bit on the basis of the measurement of said parameter and stores, for each bit of the sequence, which base was selected;
after the reception step, the second device (D_BOB) sends, to the first device (D_ALICE) and on the classical channel, the indication of the base that the second device (D_BOB) has selected for each bit of the sequence of bits as stored and receives, from said first device (D_ALICE) and on the classical channel, the indication of the base that said first device (D_ALICE) has selected to code each bit of the sequence;
comparing, for each bit of the sequence, the stored and received base indications and identifying the bits of the sequence for which the base selected by the first device and the second device are identical;
the first, second and third sets of bits consist of bits thereby identified.

9. A computer program intended to be stored in the memory of a second device (D_BOB) and furthermore comprising a microcomputer, said computer program comprising instructions that, when they are executed on the microcomputer, implement the steps of a method as claimed in claim 6.

10. A telecommunications device (D_BOB) designed to be connected to a first telecommunications link and to be connected to a second telecommunications link connecting said device to another telecommunications device (D_ALICE),
said first link being an optical transmission link and being referred to hereinafter as a quantum channel, said second remote transmission link being referred to hereinafter as a classical channel;
said device (D_BOB) being designed to receive a sequence of light pulses on the quantum channel and, for each light pulse of the received sequence of pulses, measure a parameter of the light pulse;
said device (D_BOB) being designed to estimate, for each light pulse, the value of at least one bit coded by said pulse on the basis of said measurement of the parameter; the bits estimated on the basis of the light pulses of the sequence defining a sequence of bits;
said device (D_BOB) being designed to perform at least one operation out of operations j and jj below:
an operation j comprising at least:
calculating parity bits on the basis of bits of said sequence; and
transmitting information relating to the calculated parity bits to the other device (D_ALICE);
an operation jj comprising at least:
receiving information from the other device and relating to parity bits calculated by said other device; and then
detecting errors in the sequence of bits on the basis of the received information relating to the parity bits;
wherein said device (D_BOB) is designed to distribute at least certain bits of the bits of the sequence into 3 distinct sets of bits, each bit being associated with an index number dependent on its rank within at least said certain bits: a first set of bits for defining a secret key, a second set of bits equal to 0 and a third set of bits equal to 1; each bit of at least the second and third sets being associated, in a memory of the device, with its index number;
if the device performs operation j, the device is designed, in said operation, to:
j0/calculate the parity bits on the basis of bits of the first set;
j1/code, in accordance with a predetermined code, the value of each calculated parity bit by way of a series of bits b1 b2 . . . bn of length n greater than or equal to 1;
j2/for each bit bi, i=1 to n: if and only if bi=0, select one of the bits of the second set and, if and only if bi=1, select one of the bits of the third set;
j3/in order to transmit the information relating to the calculated parity bits: transmit, on the classical channel and for each calculated parity bit, a series ind1 ind2 . . . indn, where indi indicates the index number associated with said bit selected in the second or third set in step j2 for the bit bi;
if the device performs operation jj, the device is designed, in said operation, to:
the information received from the other device comprising, for each of said parity bits, a series ind1 ind2 . . . indn, where indi, i=1 to n with n≥1, indicates an index number associated with a bit in the second or third set, for each parity bit: determine the value of the bit bi associated, in the memory of the device, with the index number indi for i=1 to n, and decode, in accordance with a determined code, the value of each parity bit on the basis of the series of bits b1 b2 . . . bn determined for said parity bit;
perform, on the basis of said values of the parity bits thereby decoded, said error detection in the first set of bits so as to define the secret key.
